(19) United States
(12) Patent Application Publication
(10) Pub. No.: US 2018/0119670 A1
(43) Pub. Date: May 3, 2018

(54) ADJUSTING DEVICE FOR ADJUSTING A ROTOR BLADE OF A WIND TURBINE

(71) Applicant: Wobben Properties GmbH, Aurich (DE)

(72) Inventor: Georg EDEN, Westerholt (DE)

(21) Appl. No.: 15/563,902

(22) PCT Filed: Apr. 7, 2016
(86) PCT No.: PCT/EP2016/057619

§ 371 Date: Oct. 2, 2017

(30) Foreign Application Priority Data
Apr. 10, 2015 (DE) 10 2015 206 488.3

(51) Int. Cl. F03D 7/02

(52) U.S. Cl. CPC F03D 7/0224; F05B 2260/79; F05B 2240/40; F05B 2260/76

(57) ABSTRACT

An adjusting device for adjusting an angle of attack of a rotor blade of a wind turbine is provided. The adjusting device comprises at least two DC motors and the at least two DC motors are electrically interconnected in series among one another at least in respective sections of the at least two DC motors.

### BACKGROUND

### Technical Field

The present invention relates to an adjusting device and to a method for adjusting an angle of attack of a rotor blade of a wind turbine. Furthermore, the present invention relates to a wind turbine comprising such an adjusting device.

### Description of the Related Art

Wind turbines that generate electrical power from wind and feed it into an electrical supply network are generally known. One example of such a wind turbine is illustrated schematically in FIG. 1.

Modern wind turbines usually comprise a rotor blade adjusting device, that is to say a device for adjusting an angle of attack of a rotor blade. Such adjusting devices, which can also be referred to as pitch adjusting device or simply as pitch devices, by adjusting the angle of attack, can both regulate the emission power of the wind turbine and limit the loading of the wind turbine at high wind speeds. For the adjustment, said adjusting devices comprise one or a plurality of motors, also referred to as pitch motors. An adjusting process for adjusting the angle of attack is also referred to as pitching.

Striving towards ever more powerful wind turbines also results, inter alia, in rotor blades becoming larger. Consequently, the requirements made of a rotor blade adjusting device also increase. Particularly the motor power of the rotor blade adjusting device increases with the size of the rotor blade.

The document EP 1 337 755 discloses an adjusting device comprising a plurality of motors for adjusting the angle of attack of a rotor blade of a wind turbine. For this purpose, the document discloses, inter alia, an electrical interconnection of a plurality of motors. What is disadvantageous about this solution is, primarily, the circumstance that an electrically unequal loading of the motors can occur, which can lead to impermissible heating of the motors and to undesired field weakening.

In the priority-substantiating German patent application the German Patent and Trademark Office searched the following documents: DE 10 2004 005 169 B3, DE 10 2007 053 613 A1, DE 297 22 109 U1, DE 692 25 995 T2, DE 893 962 B, DE 19 37 306 A, FR 972 025 A and EP 1 337 755 A1.

### BRIEF SUMMARY

Provided is an adjusting device which enables an equal loading of at least two DC motors. At least an alternative solution in relation to what has been known heretofore is provided.

An adjusting device is provided.

Consequently, an adjusting device for adjusting an angle of attack of a rotor blade of a wind turbine is proposed, wherein the adjusting device comprises at least two DC motors, and the at least two DC motors are electrically interconnected in series to one another at least in sections.

DC motors are rotary electrical machines that are operated with direct current and comprise an immobile part, the stator, and a mobile part, the rotor. Conventional DC motors are designed such that the rotor forms the inner part of the DC machine and comprises at least one winding, the armature winding, and the stator is embodied either as permanently excited, that is to say with a permanent magnet, or with at least one winding, the excitation winding.

The at least two DC motors of the proposed adjusting device comprise excitation and field windings and/or armature windings; these can be electrically interconnected in series completely or at least in sections. An electrical interconnection in series can also be referred to as series connection. For an interconnection of the at least two DC motors in sections, for example, the excitation windings and/or armature windings of the at least two DC motors can be electrically interconnected in series. Consideration is also given to interconnecting in series only a portion of the windings in each case. For a complete interconnection of the at least two DC motors, in particular all armature and excitation windings are electrically interconnected in series with one another. Furthermore, consideration can also be given to dividing the armature and/or excitation windings of the at least two DC motors into sections, in particular winding sections. Said winding sections then, exactly like the armature and excitation windings, in particular as a two-terminal network, are driven by a voltage source, in particular supplied with current.

An electrical interconnection in series constrains the same current through the windings of such a series connection, this being substantiated by Kirchhoff's current law. Consequently, at least for the windings or winding sections of the at least two DC motors that are electrically interconnected in series, what is achieved is that the same current flows through them. As a result, the at least two DC motors, on account of the proportional current-torque relationship of a DC motor, have identical mechanical moments, in particular drive forces, independently of whether for example one of the at least two DC motors has an altered internal resistance as a result of, for example, heating of the DC motor. In the case of a parallel connection, unequal internal resistances of the at least two DC motors would disadvantageously result in different currents within the at least two DC motors and thus to different mechanical moments. That is now avoided.

Preferably, the at least two DC motors are mechanically coupled.

The at least two DC motors can thus be directly or indirectly mechanically coupled, in particular to one another. In the case of a direct mechanical coupling of the at least two DC motors, the rotors can be arranged on a common shaft or form said common shaft. For this purpose, for example, the armature windings of the at least two DC motors are arranged on the same shaft and drive the latter during operation.

In the case of an indirect mechanical coupling of the at least two DC motors, the latter comprise separate rotors. The armature windings of the at least two DC motors are thus arranged on different shafts on which they act. The mechanical coupling of the rotors can be made, for example, via a common coupling element such as a toothed rim. By way of example, such a toothed rim can be arranged on a rotor blade root, such that both rotors are mechanically coupled via said toothed rim and in this case simultaneously act jointly on the blade root and can adjust the blade in terms of its angle of attack.

As a result of the mechanical coupling of the at least two DC motors, the drive forces are distributed mechanically uniformly between the at least two DC motors and, as a result of the series connection, what is achieved for this purpose is that electrically identical torques are also applied.

In accordance with one embodiment, it is proposed that in each case two motors act on a toothed rim in pairs, particularly such that in each case two motors electrically connected in series with one another form a motor pair and are also arranged spatially adjacent to one another. Preferably, two, three or more of such motor pairs are arranged on a toothed rim. As a result, each motor pair can utilize the described advantages of the series connection.

Preferably, the motors are received in motor receptacles in order from there to engage on the toothed rim. In this case, the motor receptacles are prepared for enabling an alteration of the position of the pitch motors, in particular in pairs. Preferably, for this purpose, provision is made of more receptacles than pitch motors, such that in each case a pitch motor or a motor pair is taken from one receptacle or two receptacles and arranged in a more expedient position in a hitherto free receptacle, in order thereby to act on a different, less worn section of the toothed rim.

Preferably, the armature windings of the at least two DC motors are electrically interconnected in series.

The generation of the torque by the armature windings can thus be ensured for both motors, or a plurality of motors, at the same level because the same current flows through both armature windings. The electrical interconnection of the armature windings electrically interconnected in series can be embodied in this case partly or completely electrically in series and/or electrically in parallel with the excitation windings of the at least two DC motors. By way of example, the armature windings can be electrically interconnected to each other in series, whereas the excitation windings are interconnected such that they are electrically isolated from one another and electrically isolated from the armature windings. What is achieved as a result is that the armature windings electrically interconnected in series can be fed separately from the excitation windings. Consequently, it is possible to achieve different families of characteristic curves, that is to say torque profiles, for example a high torque at standstill, by means of the driving. At the same time it is possible to avoid different torques between the motors.

As a result of the armature windings of the at least two DC motors being electrically interconnected in series, the same current flows through the armature windings of the at least two DC motors. As a result, the at least two DC motors are loaded equally on the armature side.

In accordance with a further configuration, it is proposed that the excitation windings of the at least two DC motors are electrically interconnected in series.

The excitation windings can be embodied as partly or completely electrically in series and/or electrically in parallel with the armature windings of the at least two DC motors. By way of example, the excitation windings electrically interconnected in series can be embodied with low resistance and can be electrically interconnected in series with the armature windings of the at least two DC motors. What is achieved thereby is that the DC motors interconnected in this way have a series-wound behavior, namely a torque behavior greatly dependent on rotational speed. Consideration can also be given to embodying the iron cores of the stators in a laminated fashion and to thus designing the at least two DC motors as universal motors, in particular single-phase series-wound motors with AC voltage.

As a result of the excitation windings of the at least two DC motors being electrically interconnected in series, the same current flows through the excitation windings of said DC motors. As a result, the at least two DC motors are loaded equally on the excitation side.

Furthermore, it is also possible according to the invention for the armature windings of the at least two DC motors and the excitation windings of the at least two DC motors to be jointly electrically interconnected in series. This would then result in a series connection comprising at least two armature windings and two excitation windings.

What is achieved by the armature and excitation windings of the at least two DC motors being completely and jointly interconnected is that one and the same current flows both through the armature windings and through the excitation windings of the at least two DC motors. The at least two DC motors are thus completely electrically coupled to one another and have a common series-wound behavior. In particular, for such an interconnection it is proposed that the excitation windings are embodied with low resistance and the DC motors are mechanically coupled. What is achieved thereby is that the at least two DC motors have a torque behavior greatly dependent on rotational speed. This is advantageous, in particular, if high starting torques are required as in the case of a rotor blade adjustment.

One preferred embodiment is characterized in that the at least two DC motors in each case comprise a second excitation winding, wherein said second excitation windings are electrically interconnected in series with one another.

The second excitation winding generates a second excitation field, wherein the second excitation field is, for example, of the same direction and same directional sense as the other or first excitation field.

By way of example, it is proposed that the respective second or respective first excitation winding is embodied as a separately excited winding in relation to the respective armature winding and the armature winding and the respective excitation winding are electrically interconnected in series. As a result, the at least two DC motors have a particularly advantageous operating behavior for adjusting an angle of attack of a rotor blade because the series connection ensures an identical current in all the motors and targeted intervention can be effected via the separate excitation. Consideration can also be given to embodying the second excitation windings such that they act as a deceleration device, in particular a motor brake.

One particularly preferred embodiment is characterized in that the at least two DC motors comprise in each case one or the second excitation winding, and the second excitation windings are electrically interconnected in series with the armature windings and/or other excitation windings of the at least two DC motors.

Alternatively, the first excitation windings electrically interconnected in series with one another can be electrically interconnected in parallel with the other windings, which is proposed in accordance with one embodiment. As a result, the at least two DC motors have both series- and shunt-wound behavior and are, thus, designed like a multiple motor, in particular double motor, where each DC motor is embodied in particular like a compound-wound motor. The advantages of a compound-wound motor can thus be utilized, but there is then the risk that the motors will not behave entirely identically.

Furthermore, it is proposed that the second excitation windings are embodied in each case as connectable windings, such that the second excitation windings can be connected and/or disconnected in each case by means of a switch. Particularly in the event of an emergency adjustment of the rotor blade, the second excitation windings can in each case be connected in series with the armature winding. As a result of the second excitation windings being connected in series, the DC motors have a series-wound behavior, that is to say a behavior that can generate a particularly high starting torque for adjusting the rotor blade. As a result of the second excitation winding being connected in series with the armature winding, said second excitation winding acts supplementarily only in one direction and this direction is chosen such that it corresponds to the direction of an emergency adjustment of the relevant rotor blade.

In one particularly preferred embodiment, the second excitation windings lie mechanically in the first excitation winding, and can lie in particular in each case in the same slot of the stator.

The voltage source thus supplies the adjusting device and, as a result of the proposed series interconnection, the same current is in each case established for the motors concerned. The motors of the adjusting unit, and thus the adjusting unit as such, can thereby be driven in a simple and at the same time uniform manner. A particularly preferred driving of the at least two DC motors is effected via the armature windings interconnected in series. For this purpose, the first and second excitation windings of the at least two DC motors are interconnected in series and supplied with a constant voltage. The armature windings of the at least two DC motors are likewise interconnected in series and driven with a variable, regulatable voltage. What is particularly advantageous in the case of such driving is that there is no need for electronic regulation that balances the torque of the two motors.

In addition, a wind turbine is proposed which is provided at least with an adjusting device according to one of the above embodiments. The advantages of the adjusting device thus benefit the wind turbine. In this case, particularly for achieving a redundancy and/or for dividing the required power, a plurality of pitch motors can be provided. As a result of the proposed interconnections, such a plurality of pitch motors can be operated in a uniform and at the same time simple and reliable manner.

Disclosed is a method for operating an adjusting device for adjusting an angle of attack of a rotor blade of a wind turbine, where at least two DC motors are used and driven for the adjustment, and where an adjusting device according to at least one of the embodiments described above is used and/or a wind turbine described above is used. Preferably, the at least two DC motors are driven in a manner such as has been described above in particular in association with at least one embodiment of an adjusting device.

### BRIEF DESCRIPTION OF THE SEVERAL VIEWS OF THE DRAWINGS

The present invention will now be explained in greater detail below by way of example on the basis of exemplary embodiments with reference to the accompanying figures.

FIG. 1: shows a schematic view of a wind turbine,

FIG. 2: schematically shows a toothed rim of a rotor blade root with pitch motors, and

FIG. 3: shows a schematic interconnection of two pitch motors electrically in series, and

FIG. 4: shows one preferred embodiment of a pitch motor.

### DETAILED DESCRIPTION

FIG. 1 shows a wind turbine 100 comprising a tower 102 and a nacelle 104. A rotor 106 comprising three rotor blades 108 and a spinner 110 is arranged on the nacelle 104. The rotor 106 is caused to effect a rotational movement by the wind during operation and thereby drives a generator in the nacelle 104.

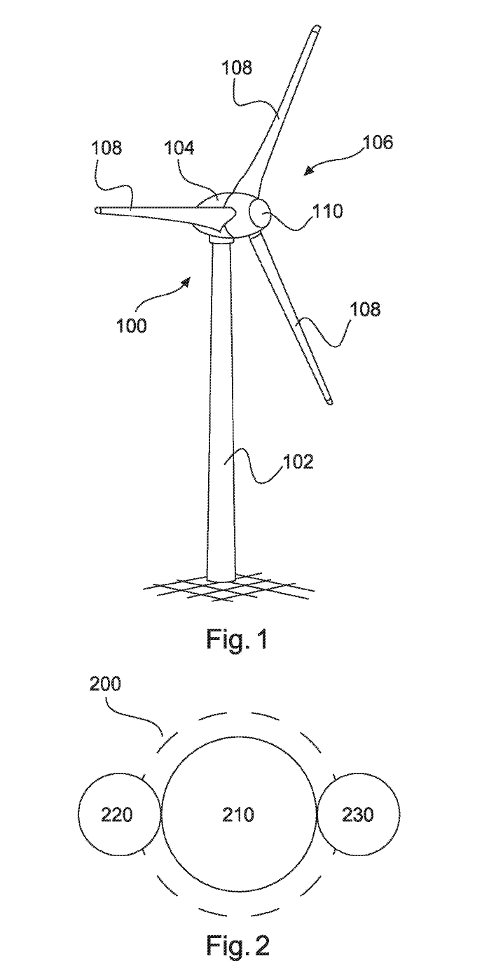

FIG. 2 illustrates a mechanical coupling 200 comprising a toothed rim 210 as a mechanical coupling element, two pitch motors 220 and 230 acting on said toothed rim and thereby being mechanically coupled. Such DC motors can be used here as pitch motors 220 and 230, wherein a series interconnection in accordance with at least one embodiment is used. The mechanical coupling element 210 is thus designed as a toothed rim 210 having an outer toothing and is fixedly attached to a rotor blade root, such that the relevant rotor blade can be rotated by the driving of the toothed rim 210 by the two pitch motors 220 and 230. The two pitch motors 220 and 230 are arranged with equal spacing on the circumference of the toothed rim 210 and engage in the outer toothing of the toothed rim by means of corresponding pinions that are respectively connected to a rotor shaft of the pitch motors 220 and 230. In the case of conventional DC motors, the rotatably mounted part of the DC motors, that is to say the rotor, is also referred to as the armature and is arranged internally on a shaft. Consideration can also be given to designing the DC motors as external rotors and/or embodying the rotor blade with an inner toothing and arranging the DC motors within the inner toothing.

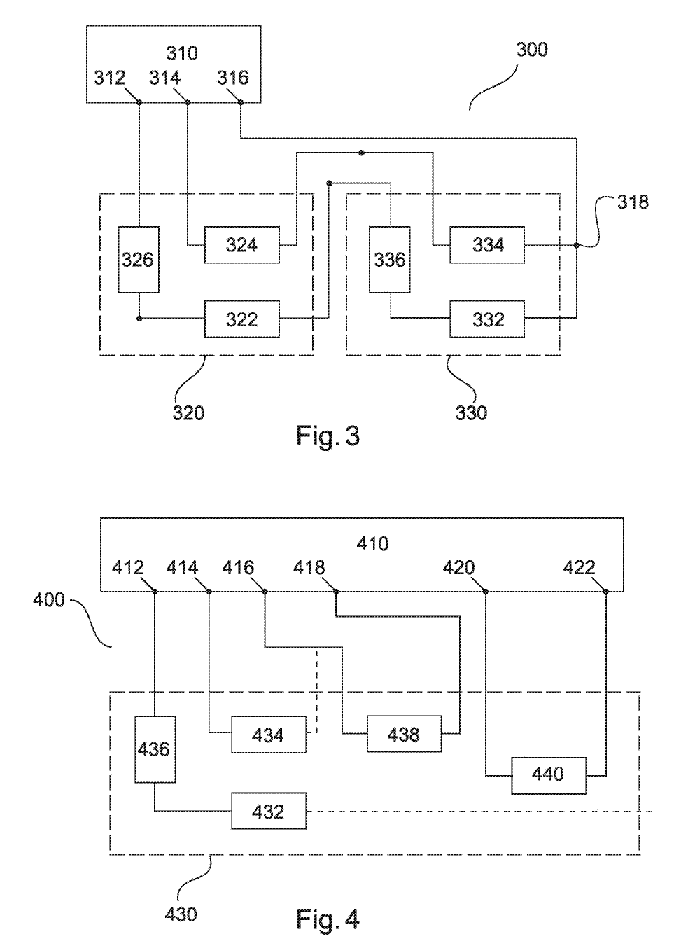

FIG. 3 shows a particularly preferred electrical interconnection 300 of a first and second DC motor 320 and 330, respectively, which can be used as first and second pitch motor 220 and 230, respectively, in accordance with FIG. 2. Furthermore, the electrical interconnection 300 comprises an electrical voltage source 310, wherein the electrical voltage source 310 is provided with three voltage-carrying outputs 312, 314 and 316. The DC motors 320 and 330 each comprise an armature winding 322 and 332, a first excitation winding 324 and 334 and a second excitation winding 326 and 336. The armature winding 322 and the second excitation winding 326 of the DC motor 320 are electrically interconnected in series in the same way as the armature winding 332 and the second excitation winding 336 of the DC motor 330. The armature and excitation windings 322 and 326, and 332 and 336, interconnected in this way are likewise electrically interconnected in series with one another and connected to the voltage-carrying output 312 of the voltage source 310, such that these four windings together are interconnected in a common series connection. The first excitation windings 324 and 334 of the DC motors 320 and 330 are likewise electrically interconnected in series and connected to the voltage-carrying output 314 of the voltage source 310. The series-interconnected armature and second excitation windings 322, 326, and 332 and 336, are jointly interconnected in parallel with the series-interconnected first excitation windings 324 and 334.

Preferably, the two second excitation windings 326 and 336 can in each case be connected or disconnected by means of a switch. Preferably, depending thereon, different voltage sources are used, which can also be referred to as current controllers. In this respect, in the embodiment shown in FIG. 3, the voltage source 310 is a current controller for operation with the second excitation windings 326 and 336, in particular for an emergency adjustment.

Consequently, the two DC motors 320 and 330 are partly electrically interconnected in series and designed as a compound machine, wherein the two DC motors interconnected in this way combine the properties of a shunt-wound motor and a series-wound motor, that is to say are compounded. Depending on the design of the windings and the driving thereof via the voltage source 310, the two DC motors 320 and 330 have different operating behaviors. If the electrical interconnection 300 is embodied as over-compounded, for example, the two DC motors 320 and 330 predominantly have series-wound behavior, that is to say a high starting torque. By contrast, if the electrical interconnection 300 is embodied as under-compounded, the two DC motors 320 and 330 predominantly have shunt-wound behavior, that is to say a high rotational speed stability.

What is particularly advantageous in the case of the electrical interconnection shown in FIG. 3 is the possibility of controlling the two DC motors 320 and 330 via the voltage source 310. A good operating behavior can be achieved as a result. The series connection proposed makes it possible to ensure an identical torque of both pitch motors 320 and 330, such that the coupling shown in FIG. 2 can also be operated well and there is no risk of one of the pitch motors 320 and 330 in accordance with FIG. 3, or 220 and 230 in accordance with FIG. 2, performing a large part of the adjustment work as a result of a small, e.g., thermally governed, inaccuracy. What is furthermore advantageous is that, as the rotor blade size increases, the adjusting device can be extended by one DC motor or further DC motors, wherein it is proposed, in particular, that all the DC motors are of the same type in this case.

FIG. 4 shows a preferred embodiment of the DC motor 430 that can be used as a pitch motor 220 and 230 in accordance with FIG. 2. Besides the excitation windings 434 and 436 and armature windings 432, the pitch motor 430 has an electrical brake 438 and an electrical fan 440. The electrical brake 438, embodied as a field brake, and the electrical fan 440 are driven by the voltage source 410. In this case, the field brake 438 is embodied such that it can weaken the excitation field of the DC motor 430 in such a way that a brake is applied to the armature of the DC motor. The field brake 438 is driven via the voltage-carrying outputs 416 and 418. The electrical fan 440 of the DC motor 430 is driven by the voltage source 410, such that, in the case where the DC motor 430 is at a standstill, said DC motor can continue to be cooled by the fan 440. The electrical fan 440 is driven via the voltage-carrying outputs 420 and 422.

1. An adjusting device for adjusting an angle of attack of a rotor blade of a wind turbine, comprising:
at least two DC motors having respective components that are electrically interconnected in series to each other.

2. The adjusting device according to claim 1, wherein the at least two DC motors are mechanically coupled to each other.

3. The adjusting device according to claim 1, wherein the at least two DC motors each comprise respective armature windings, and wherein the armature windings of the at least two DC motors are electrically interconnected in series to each other.

4. The adjusting device according to claim 3, wherein the at least two DC motors each comprise respective first excitation windings, and wherein the first excitation windings of the at least two DC motors of the are electrically interconnected in series to each other.

5. The adjusting device according to claim 4, wherein the respective armature windings of the at least two DC motors and the respective first excitation windings of the at least two DC motors are jointly electrically interconnected in series.

6. The adjusting device according to claim 4, wherein each DC motor of the at least two DC motors comprises second excitation winding, wherein the second excitation windings of the at least two DC motors are electrically interconnected in series with one another.

7. The adjusting device according to claim 6, wherein the second excitation windings of the at least two DC motors are electrically interconnected in series with at least one of the armature windings and the excitation windings of the at least two DC motors.

8. The adjusting device according to claim 6, wherein the second excitation windings of each of the at least two DC motors are connectable windings.

9. The adjusting device according to claim 1, wherein the adjusting device comprises a voltage source configured to supply power to armature and excitation voltages of the at least two DC motors.

10. A wind turbine comprising a rotor comprising:
at least one adjustable rotor blade; and
at least one adjusting device according to claim 1, the at least one adjusting device for adjusting an angle of attack of the at least one rotor blade.

11. A method comprising:
operating an adjusting device for adjusting the angle of attack of the rotor blade of the wind turbine, wherein operating the adjusting device comprises using at least two DC motors to make the adjustment.
